(19) United States
(12) Patent Application Publication
(10) Pub. No.: US 2026/0179614 A1
(43) Pub. Date: Jun. 25, 2026

(54) VOICE RECOGNITION RESULT DISPLAY APPARATUS, METHOD AND PROGRAM

(71) Applicant: NTT, Inc, Tokyo (JP)

(72) Inventors: Hiroko MUTO, Musashino-shi, Tokyo (JP); Takaaki FUKUTOMI, Musashino-shi, Tokyo (JP); Kenichi MORIMOTO, Musashino-shi, Tokyo (JP); Taichi ASAMI, Musashino-shi, Tokyo (JP); Takanori ASHIHARA, Musashino-shi, Tokyo (JP); Hiroshi SATO, Musashino-shi, Tokyo (JP); Kohei MATSUURA, Musashino-shi, Tokyo (JP); Takafumi MORIYA, Musashino-shi, Tokyo (JP)

(73) Assignee: NTT, Inc, Tokyo (JP)

(21) Appl. No.: 19/126,250

(22) PCT Filed: Jul. 12, 2023
(86) PCT No.: PCT/JP2023/025741

§ 371 Date: May 1, 2025

(30) Foreign Application Priority Data
Nov. 2, 2022 (WO) PCT/JP2022/040952

(51) Int. Cl. G10L 15/22

(52) U.S. Cl. CPC G10L 15/22; G10L 2015/221

(57) ABSTRACT

A speech recognition result display device includes a display unit that displays a speech recognition result text that is a text of a speech recognition result of a latest utterance and a summary text that is a text obtained by summarizing the speech recognition result text of an utterance that is more past than the latest utterance in a display region of an utterance content in a screen.

### TECHNICAL FIELD

The disclosed technology relates to a technology for displaying utterance content obtained from a speech recognition result.

### BACKGROUND ART

A technique for displaying a speech recognition result text that is a text representing an utterance itself obtained by performing speech recognition on the utterance and a summary text that is a text obtained by summarizing the speech recognition result text is described in, for example, Patent Literature 1 and Patent Literature 2.

The technique of Patent Literature 1 is a technique for displaying utterance content in a conversation between a customer and a person in charge of reception. Patent Literature 1 describes a technique of displaying a text of an utterance summary regarding a matter of business in addition to speech recognition result texts of all utterances of a customer and a person in charge of reception.

The technique of Patent Literature 2 is a technique for accurately displaying all utterances in a conference. Patent Literature 2 describes a technique of displaying a summary text only while a speech recognition result text is being corrected although the speech recognition result text is normally displayed.

### CITATION LIST

### Patent Literature

Patent Literature 1: JP 2018-128577 A

Patent Literature 2: JP 2017-161850 A

### SUMMARY OF INVENTION

### Technical Problem

In the technique of Patent Literature 1, in addition to the speech recognition result texts of all the utterances of the customer and the person in charge of reception, a text of an utterance summary regarding the matter of business is also displayed. For this reason, the technique of Patent Literature 1 has a problem that it is difficult to visually recognize the display when there is a restriction on a size of a display screen for displaying the utterance content.

In the technique of Patent Literature 2, the summary text may be displayed for an utterance for which the speech recognition result text is being corrected among the utterances in the conference, but the speech recognition result text is displayed for an utterance other than the utterance for which correction is being made among the utterances in the conference. For this reason, the technique of Patent Literature 2 also has a problem that it is difficult to visually recognize the display when there is a restriction on the size of the display screen for displaying the utterance content.

An object of the disclosed technology is to display utterance content so that it is not difficult to visually recognize the display even when there is a restriction on a size of a display screen for displaying the utterance content.

### Solution to Problem

One aspect of the disclosed technology is a speech recognition result display device including a display unit that displays a speech recognition result text that is a text of a speech recognition result of a latest utterance and a summary text that is a text obtained by summarizing the speech recognition result text of an utterance that is more past than the latest utterance in a display region of an utterance content in a screen.

### ADVANTAGEOUS EFFECTS OF INVENTION

According to the disclosed technology, even in a case where there is a restriction on the size of the display screen for displaying the utterance content, the utterance content can be displayed so that the display is not difficult to visually recognize.

### BRIEF DESCRIPTION OF DRAWINGS

FIG. 1 is a diagram illustrating an example of a functional configuration of a speech recognition result display device.

FIG. 2 is a diagram illustrating an example of a processing procedure of a speech recognition result display method.

FIG. 3 is a diagram illustrating a functional configuration example of a device in which the speech recognition result display device is implemented.

FIG. 4 is a diagram illustrating an example of a display region.

FIG. 5 is a diagram illustrating an example of the display region.

FIG. 6 is a diagram illustrating an example of the display region.

FIG. 7 is a diagram illustrating an example of the display region.

FIG. 8 is a diagram illustrating a functional configuration example of a computer.

FIG. 9 is a diagram illustrating an example of the display region.

FIG. 10 is a diagram illustrating an example of the display region.

FIG. 11 is a diagram illustrating an example of the display region.

FIG. 12 is a diagram illustrating an example of a functional configuration of the speech recognition result display device.

FIG. 13 is a diagram illustrating an example of the display region.

FIG. 14 is a diagram illustrating an example of the display region.

### DESCRIPTION OF EMBODIMENTS

Hereinafter, an embodiment of the disclosed technique will be described with reference to the drawings. Note that, in the drawings, components having the same functions are denoted by the same reference numerals, and redundant description will be omitted.

### Speech Recognition Result Display Device and Method

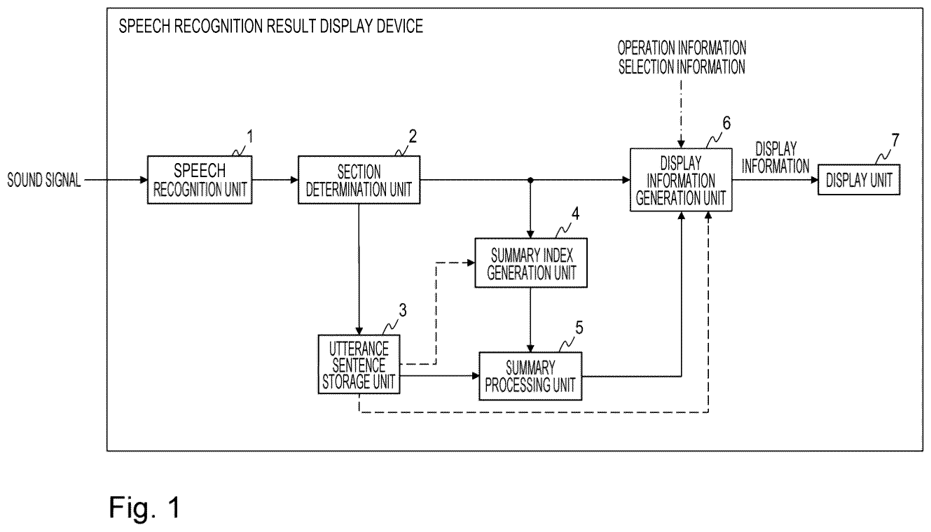

As illustrated in FIG. 1, the speech recognition result display device includes, for example, a speech recognition unit 1, a section determination unit 2, an utterance sentence storage unit 3, a summary index generation unit 4, a summary processing unit 5, a display information generation unit 6, and a display unit 7.

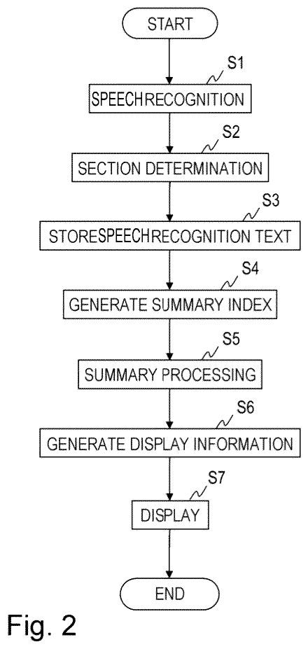

The speech recognition result display method is implemented, for example, by each component of the speech recognition result display device performing processing of steps S1 to S7 illustrated in FIG. 2.

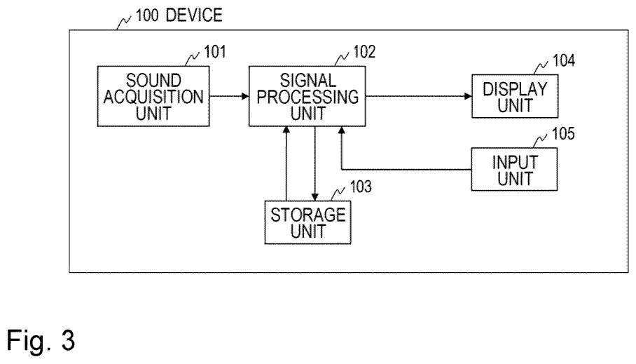

The speech recognition result display device is, for example, a device 100 having a relatively small screen, such as a smartphone, a phablet, a tablet, a smartwatch, a mobile phone, a PDA, or a portable game machine. FIG. 3 illustrates an example of the device 100 having a relatively small screen.

As illustrated in FIG. 3, the device 100 includes a sound acquisition unit 101, a signal processing unit 102, a storage unit 103, a display unit 104, and an input unit 105.

The sound acquisition unit 101 includes, for example, a microphone and an AD converter. The sound acquisition unit 101 collects a sound generated in a surrounding space with a microphone, and outputs a digital sound signal obtained by AD converting the collected sound with an AD converter to the signal processing unit 102.

The signal processing unit 102 is, for example, a central processing unit (CPU). The signal processing unit 102 generates display information of a screen displaying utterance content from the input digital sound signal and outputs the display information to the display unit 104.

The storage unit 103 is a main storage device such as a random access memory (RAM).

The display unit 104 is a display device having a screen such as a liquid crystal display (LCD) or an organic electroluminescence display (OLED). The display unit 104 performs display based on the input display information. The display unit 104 is also the display unit 7 to be described later.

The input unit 105 is an input device such as a touch panel, a mouse, and a pointing device such as a track ball. When the user performs an input operation using the input unit 105, operation information and selection information to be described later are generated. The generated operation information and selection information are input to the signal processing unit 102.

Note that the display unit 104 and the input unit 105 may be the same hardware such as a touch screen.

Note that even in a case where some components of the device 100 are connected by communication such as Bluetooth (registered trademark) and provided in another device physically away from the device 100, the components are also included in the device 100.

A sound signal obtained by the sound acquisition unit 101 is input to cause the signal processing unit 102, the storage unit 103, the display unit 104, and the input unit 105 to perform processing of each component (the speech recognition unit 1, the section determination unit 2, the utterance sentence storage unit 3, the summary index generation unit 4, the summary processing unit 5, the display information generation unit 6, and the display unit 7) of the speech recognition result display device, whereby the speech recognition result display device is implemented on the device 100.

Hereinafter, processing of the speech recognition result display method performed by each component of the speech recognition result display device will be described.

### Speech Recognition Unit 1

A digital sound signal is sequentially input to the speech recognition unit 1.

The speech recognition unit 1 performs speech recognition processing on the input digital sound signal to obtain a speech recognition result text that is a text of a speech recognition result (step S1). The speech recognition result text obtained by the speech recognition unit 1 represents an utterance for each utterance unit included in the sequentially input sound signal with characters. As the speech recognition processing, it is sufficient if existing processing is used. That is, the speech recognition unit 1 obtains a speech recognition result text of a latest utterance unit.

The obtained speech recognition result text is output to the section determination unit 2.

### Section Determination Unit 2

The speech recognition result text of the utterance unit obtained by the speech recognition unit 1 is sequentially input to the section determination unit 2.

That is, the speech recognition result text of the latest utterance unit is input to the section determination unit 2.

The section determination unit 2 determines whether the input speech recognition result text of the latest utterance unit belongs to the same section as a speech recognition text of the immediately preceding utterance unit, and obtains section identification information that specifies a section to which the latest utterance unit belongs (step S2). The condition of belonging to the same section is being on the same topic and the number of characters is equal to or less than a predetermined number of characters for displaying the latest section. The section identification information is information for specifying the time order of the sections, and is, for example, a number added to each section in time order.

The obtained section identification information of the section to which the latest utterance unit belongs is combined with the speech recognition result text of the latest utterance unit and output to the utterance sentence storage unit 3, the summary index generation unit 4, and the display information generation unit 6.

For example, in a case where the speech recognition result text of the latest utterance unit and the speech recognition result text of the immediately preceding utterance unit relate to the same topic, and the sum of the number of characters of the speech recognition result text of the same section identification information as the speech recognition result text of the immediately preceding utterance unit and the number of characters of the speech recognition result text of the latest utterance unit is equal to or less than the predetermined number of characters, the section determination unit 2 obtains the same section identification information as the immediately preceding utterance unit as the section identification information of the latest utterance unit, or otherwise, that is, in a case corresponding to at least one of a case where the speech recognition result text of the latest utterance unit and the speech recognition result text of the immediately preceding utterance unit do not relate to the same topic, or a case where the sum of the number of characters of the speech recognition result text of the same section identification information as the speech recognition result text of the immediately preceding utterance unit and the number of characters of the speech recognition result text of the latest utterance unit is larger than the predetermined number of characters, new section identification information different from any section identification information in the past is obtained as the section identification information of the latest utterance unit (step S2A).

As processing of determining whether or not the speech recognition result text in the latest utterance unit and the speech recognition result text in the immediately preceding utterance unit relate to the same topic, existing topic determination processing can be used.

Note that the condition of belonging to the same section may be that it is within a predetermined time from the start of the section and the number of characters is equal to or less than the number of characters predetermined for displaying the latest section. For example, in a case where the time from the start time of an utterance of the speech recognition source of the speech recognition result text of the same section identification information as the speech recognition result text of the immediately preceding utterance unit to the end time of the utterance of the speech recognition source of the speech recognition result text of the latest utterance unit is within a predetermined time, and the sum of the number of characters of the speech recognition result text of the Same section identification information as the speech recognition result text of the immediately preceding utterance unit and the number of characters of the speech recognition result text of the latest utterance unit is equal to or less than the predetermined number of characters, the section determination unit 2 obtains the same section identification information as the immediately preceding utterance unit as the section identification information of the latest utterance unit, or otherwise, that is, in a case corresponding to at least one of a case where the time from the start time of the utterance of the speech recognition source of the speech recognition result text of the same section identification information as the speech recognition result text of the immediately preceding utterance unit to the end time of the utterance of the speech recognition source of the speech recognition result text of the latest utterance unit exceeds the predetermined time, or a case where the sum of the number of characters of the speech recognition result text of the same section identification information as the speech recognition result text of the immediately preceding utterance unit and the number of characters of the speech recognition result text of the latest utterance unit is larger than the predetermined number of characters, new section identification information different from any section identification information in the past is obtained as the section identification information of the latest utterance unit (step S2B).

In addition, without including being on the same topic in the condition of belonging to the same section, the condition of belonging to the same section may be being equal to or less than the number of characters determined in advance for display of the latest section. For example, in a case where the sum of the number of characters of the speech recognition result text of the same section identification information as the speech recognition result text of the immediately preceding utterance unit and the number of characters of the speech recognition result text of the latest utterance unit is equal to or less than the predetermined number of characters, the section determination unit 2 may obtain the same section identification information as the immediately preceding utterance unit as the section identification information of the latest utterance unit, or otherwise, that is, in a case where the sum of the number of characters of the speech recognition result text of the same section identification information as the speech recognition result text of the immediately preceding utterance unit and the number of characters of the speech recognition result text of the latest utterance unit is larger than the predetermined number of characters, new section identification information different from any section identification information in the past may be obtained as the section identification information of the latest utterance unit (step S2C).

### Utterance Sentence Storage Unit 3

A set of the speech recognition result text and the section identification information of the utterance unit obtained by the section determination unit 2 is sequentially input to the utterance sentence storage unit 3. That is, a set of the speech recognition result text and the section identification information of the latest utterance unit is input to the utterance sentence storage unit 3.

The utterance sentence storage unit 3 stores a set of the speech recognition result text and the section identification information of each utterance unit including a newly input set of the speech recognition result text and the section identification information of the latest utterance unit, and outputs the set as necessary (step S3).

### Summary Index Generation Unit 4

The summary index generation unit 4 obtains a summary index that is an index indicating what kind of summary is to be performed on the speech recognition result text in a section having section identification information different from that of the speech recognition result text of the latest utterance unit (step S4).

The obtained summary index is output to the summary processing unit 5.

Examples of the summary index are a recommended number of characters of a summary, a recommended number of display lines of the summary, a recommended compression rate of the summary, and information indicating that content words are set as the summary.

As will be described later, in the display region of the display unit 7, the speech recognition result text of the latest section and the summary text of one or more sections immediately before the latest section are displayed. If the size of the region in which the speech recognition result text of the latest section is displayed is variable, the size of the region in which the summary text of one or more sections immediately before the latest section is displayed is also variable. For example, in a case where the size of the region in which the summary text is displayed is determined depending on the size of the region in which the speech recognition result text of the latest section is displayed, the summary index generation unit 4 only needs to obtain the recommended number of characters determined from the number of characters of the speech recognition result text of the latest section as the summary index, obtain the recommended number of display lines of the summary determined from the number of lines for displaying the speech recognition result text of the latest section as the summary index, or obtain the recommended compression rate of the summary determined from the number of characters of the speech recognition result text of the latest section and the number of characters of the speech recognition result text of the section to be subjected to summarization.

### Example of Obtaining Recommended Number of Characters of Summary as Summary Index

The set of the speech recognition result text and the section identification information of the utterance unit obtained by the section determination unit 2 is sequentially input to the summary index generation unit 4. That is, the set of the speech recognition result text and the section identification information of the latest utterance unit obtained by the section determination unit 2 is input to the summary index generation unit 4. The summary index generation unit 4 stores in advance the maximum number of characters that can be displayed in the display region of the display unit 7.

The summary index generation unit 4 acquires the speech recognition result text grouped in a set with the same section identification information as the section identification information of the latest utterance unit from the utterance sentence storage unit 3 (step S4A-1).

The summary index generation unit 4 obtains the total number of characters of the speech recognition result text of the latest utterance unit and the speech recognition result text acquired in step S4A-1 (step S4A-2). The total number of characters acquired in step S4A-2 is the number of characters of the speech recognition result text of the latest section. The summary index generation unit 4 obtains a value obtained by subtracting the number of characters of the speech recognition result text of the latest section acquired in step S4A-2 from the maximum number of characters that can be displayed in the display region of the display unit 7 as the recommended number of characters of the summary (step S4A-3).

### Example of Obtaining Recommended Number of Display Lines; of Summary as Summary Index

The set of the speech recognition result text and the section identification information of the utterance unit obtained by the section determination unit 2 is sequentially input to the summary index generation unit 4. That is, the set of the speech recognition result text and the section identification information of the latest utterance unit obtained by the section determination unit 2 is input to the summary index generation unit 4. In the summary index generation unit 4, the maximum number of lines that can be displayed in the display region of the display unit 7 and the number of characters per row are stored in advance.

The summary index generation unit 4 acquires the speech recognition result text grouped in a set with the same section identification information as the section identification information of the latest utterance unit from the utterance sentence storage unit 3 (step S4B-1). The summary index generation unit 4 obtains the total number of characters of the speech recognition result text of the latest utterance unit and the speech recognition result text acquired in step S4B-1 (step S4B-2). The total number of characters acquired in step S4B-2 is the number of characters of the speech recognition result text of the latest section. The summary index generation unit 4 obtains a value obtained by dividing the total number of characters acquired in step S4B-2 by the number of characters per line and rounding up to the whole number as the number of display lines of the speech recognition result text of the latest section (step S4B-3). The summary index generation unit 4 obtains a value obtained by subtracting the number of display lines of the speech recognition result text of the latest section acquired in step S4B-3 from the maximum number of lines that can be displayed in the display region of the display unit 7, as the recommended number of display lines of the summary (step S4B-4).

### Example of Obtaining Recommended Compression Rate of Summary as Summary Index

The set of the speech recognition result text and the section identification information of the utterance unit obtained by the section determination unit 2 is sequentially input to the summary index generation unit 4. That is, the set of the speech recognition result text and the section identification information of the latest utterance unit obtained by the section determination unit 2 is input to the summary index generation unit 4. In the summary index generation unit 4, the maximum number of characters that can be displayed in the display region of the display unit 7 and the number of summary sections, which is the number of sections to be subjected to summary display, are stored in advance.

The summary index generation unit 4 acquires the speech recognition result text grouped in a set with the same section identification information as the section identification information of the latest utterance unit from the utterance sentence storage unit 3 (step S4C-1). The summary index generation unit 4 obtains the total number of characters of the speech recognition result text of the latest utterance unit and the speech recognition result text acquired in step S4C-1 (step S4C-2). The total number of characters acquired in step S4C-2 is the number of characters of the speech recognition result text of the latest section. The summary index generation unit 4 obtains a value obtained by subtracting the number of characters of the speech recognition result text of the latest section acquired in step S4C-2 from the maximum number of characters that can be displayed in the display region of the display unit 7 as the recommended number of characters of the summary (step S4C-3).

The summary index generation unit 4 acquires, from the utterance sentence storage unit 3, the speech recognition result text of sections corresponding to the number of consecutive summary sections including a section that is more past than the section including the latest utterance unit and immediately before the section including the latest utterance unit (step S4C-4). Specifically, the summary index generation unit 4 specifies, from the section identification information of the latest utterance unit, the section identification information of sections corresponding to the number of consecutive summary sections including a section that is more past than the section including the latest utterance unit and immediately before the section including the latest utterance unit, and acquires a speech recognition result text grouped in a set with the specified section identification information. The summary index generation unit 4 obtains the total number of characters of the speech recognition result text acquired in step S4C-4 (step S4C-5). The total number of characters acquired in step S4C-5 is the number of characters of the speech recognition result text of the section to be subjected to the summary display.

The summary index generation unit 4 obtains, as a recommended compression rate of the summary, a value obtained by subtracting, from 1, a value obtained by dividing the recommended number of characters of the summary acquired in step S4C-3 by the total number of characters of the speech recognition result text of the past section to be subjected to the summary display acquired in step S4C-5 (step S4C-6).

### Example of Obtaining Information Indicating That Content Words are Set ss Summary Index

When the information indicating that content words are set as the summary is used as the summary index, nothing needs to be input to the summary index generation unit 4, and the summary index generation unit 4 only needs to obtain the information indicating that the content words are set as the summary as the summary index. In this case, the summary processing unit 5 always performs summary processing setting the content words as the summary, and thus the summary index generation unit 4 need not obtain the summary index, and the speech recognition result display device need not include the summary index generation unit 4.

### Summary Processing Unit 5

The summary index obtained by the summary index generation unit 4 is sequentially input to the summary processing unit 5. That is, the summary index obtained by the summary index generation unit 4 in the processing for the latest utterance unit is input to the summary processing unit 5. Furthermore, the summary processing unit 5 reads the speech recognition result text of each section to be subjected to the summary display from the utterance sentence storage unit 3.

The summary processing unit 5 performs summary processing on the speech recognition result text of each section to be subjected to the summary display according to the summary index to obtain the summary text of each section (step S5).

Note that the section to be subjected to the summary display is one or more sections immediately before the section including the latest utterance unit. In a case where the number of sections is one, the one or more sections immediately before the section including the latest utterance unit are a section immediately before the section including the latest utterance unit, and in a case where the number of sections is plural, the one or more sections immediately before the section including the latest utterance unit are a plurality of consecutive sections including the section immediately before the section including the latest utterance unit and a section that is more past than the section including the latest utterance unit.

Therefore, the summary processing unit 5 reads the speech recognition result text of one or more sections immediately before the section including the latest utterance unit from the utterance sentence storage unit 3, and performs summary processing on the read speech recognition result text of each read section so that the read summary text of all sections follows the summary index, thereby obtaining the summary text of each section. That is, the summary processing unit 5 obtains a summary text that is a text obtained by summarizing the speech recognition result text of the utterance that is more past than the latest utterance.

The obtained summary text is output to the display information generation unit 6.

Existing summary processing can be used for the summary processing.

For example, in a case where the summary index is the recommended number of characters of the summary, the summary processing unit 5 performs the summary processing so that the total number of characters of the summary text of all sections to be subjected to the summary display is equal to or less than the recommended number of characters, or so that the total number of characters of the summary text of all sections to be subjected to the summary display is as close as possible to the recommended number of characters.

For example, in a case where the summary index is the recommended number of display lines of the summary, the summary processing unit 5 performs the summary processing so that the number of display lines of the summary text of all the sections to be subjected to the summary display is equal to or less than the recommended number of display lines, or so that the number of display lines of the summary text of all the sections to be subjected to the summary display is as close as possible to the recommended number of display lines.

For example, in a case where the summary index is the recommended compression rate of the summary, the summary processing unit 5 performs the summary processing so that the compression rate from the speech recognition result text of all sections to be subjected to the summary display to the summary text of all sections to be subjected to the summary display is equal to or higher than the recommended compression rate, or so that the compression rate from the speech recognition result text of all sections to be subjected to the summary display to the summary text of all sections to be subjected to the summary display is as close as possible to the recommended compression rate, or so that the compression rate from the speech recognition result text of each section to be subjected to the summary display to the summary text is equal to or higher than the recommended compression rate, or so that the compression rate from the speech recognition result text of each section to be subjected to the summary display to the summary text is as close as possible to the recommended compression rate.

For example, in a case where the summary index is the information indicating that content words are set as the summary, the summary processing unit 5 performs the summary processing by acquiring content words representing the content of the speech recognition result text of each section for each section to be subjected to the summary display.

As can be seen from the above examples, the summary text is a text obtained by summarizing the speech recognition result text of the section to be subjected to the summary display. The summary text may include only the content words of the speech recognition result text.

### Display Information Generation Unit 6

The speech recognition result text and the section identification information of the utterance unit obtained by the section determination unit 2 and the summary text obtained by the summary processing unit 5 are sequentially input to the display information generation unit 6. That is, to the display information generation unit 6, the speech recognition result text and the section identification information of the latest utterance unit, and the summary text obtained by the summary processing unit 5 in the processing for the latest utterance unit are input. In a case where the speech recognition result text grouped in a set with the same section identification information as the section identification information of the latest utterance unit is stored in the utterance sentence storage unit 3, that is, in a case where the speech recognition result text of the same section as the latest utterance is stored in the utterance sentence storage unit 3, as indicated by a broken line in FIG. 1, the speech recognition result text grouped in a set with the same section identification information as the section identification information of the latest utterance unit stored in the utterance sentence storage unit 3 is also input to the display information generation unit 6. As described above, the speech recognition result text of the latest section and the summary text of one or more sections immediately before the latest section are input to the display information generation unit 6. The one or more sections immediately before the latest section are a section immediately before the latest section or a plurality of consecutive sections including a section immediately before a section including the latest utterance unit and more past than a section including the latest utterance unit.

Further, as indicated by a one-dot chain line in FIG. 1, the operation information and the selection information may be input to the display information generation unit 6 as necessary. The operation information and the selection information are information generated when the user performs an input operation using the input unit 105. A moving operation of a scroll bar slider described later is performed, for example, according to the input operation information. Further, for example, a summary text to be described later is selected according to the input selection information.

The display information generation unit 6 generates display information that is information of an image to be displayed on the display unit 7 (step S6). More specifically, the display information is information of an image that displays the speech recognition result text and the summary text in a display region for the utterance content in the screen of the display unit 7.

The generated display information is output to the display unit 7. As described later, the display unit 7 performs display based on the display information.

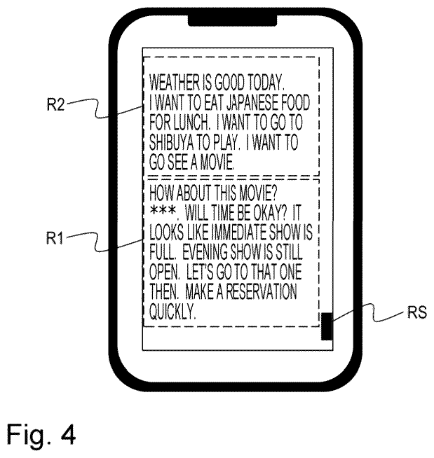

Hereinafter, an example of the display region of the utterance content displayed on the display unit 7 on the basis of the display information generated by the display information generation unit 6 will be described with reference to FIGS. 4 to 7. The following description will be given assuming that the n-th section is Tₙ, the speech recognition result text of the section Tₙ is Full (Tₙ), and the summary text of the section Tₙ is Summ (Tₙ). Note that, in each example, it is assumed that each text is displayed with a predetermined character size.

### First Example of Display Region

In the first example of the display region, the speech recognition result text of the latest section and the summary text of one or more sections immediately before the latest section are displayed in time order in the display region.

A case where the latest section is T_{N} is defined as a first state. In the first state, in the display region, the speech recognition result text Full (T_{N}) of the latest section T_{N} and the summary texts Summ (T_{N-1}) , Summ (T_{N-2}), . . . of past consecutive sections T_{N-1}, T_{N-2}, . . . including the section T_{N-1} immediately before the latest section are displayed in time order.

FIG. 4 is a specific example of the display region in the first state, and in the display region, “The weather is good today.” which is the summary text Summ (T_{N-4}) of the section T_{N-4}, “I want to eat Japanese food for lunch.” which is the summary text Summ (T_{N-3}) of the section T_{N-3}, “I want to go to Shibuya to play.” which is the summary text Summ (T_{N-2}) of the section T_{N-2}, “I want to go see a movie.” which is the summary text Summ (T_{N-1}) of the section T_{N-1}, and “How about this movie. ˜Make a reservation quickly.” which is the speech recognition result text Full (T_{N}) of the latest section T_{N}, are displayed in time order. That is, in FIG. 4, in the display region, the speech recognition result text of the latest section and the summary texts of past four consecutive sections including the section immediately before the latest section are displayed in time order.

A region in the display region where the speech recognition result text Full (T_{N}) is displayed is referred to as a first partial region R1, and a region in the display region where the summary texts Summ (T_{N-1}), Summ (T_{N-2}), . . . are displayed is referred to as a second partial region R2. The second partial region R2 is a remaining region after displaying the first partial region R1 is displayed in the display region. Therefore, in the second partial region R2, a displayable amount of the summary texts of the consecutive past sections including the section T_{N-1} is displayed. That is, in FIG. 4, the summary text of the past four sections is displayed, but how much the summary text of past sections is displayed in the display region depends on the number of characters and the number of lines required to display the speech recognition result text and the summary text.

A case where the speech recognition unit 1 has obtained the speech recognition result text of the new utterance unit after the first state and the speech recognition result text of the new utterance unit obtained by the speech recognition unit 1 belongs to the section T_{N} is defined as the second state. In the second state, the latest section is the same T_{N} as in the first state. Therefore, in the second state, similarly to the first state, the speech recognition result text Full (T_{N}) of the latest section Ty and the summary texts Summ (T_{N-1}) , Summ (T_{N-2}) of the past consecutive sections T_{N-1}, T_{N-2}, . . . including the section T_{N-1} immediately before the latest section are displayed in the display region in time order. However, in the second state, the number of characters of the speech recognition result text Full (T_{N}) in the latest section T_{N} is larger than that in the first state, and thus the number of characters of the summary text displayed in the display region is smaller than that in the first state.

A case where the speech recognition unit 1 obtains the speech recognition result text of the new utterance unit after the second state and the speech recognition result text of the new utterance unit obtained by the speech recognition unit 1 does not belong to the section T_{N} is defined as a third state. In the third state, the latest section is T_{N+1}. Therefore, in the third state, in the display region, the speech recognition result text Full (T_{N+1}) of the latest section T_{N+1} and the summary texts Summ (T_{N}) , Summ (T_{N-1}) , . . . of the past consecutive sections T_{N}, T_{N-1}, . . . including the section T_{N} immediately before the latest section are displayed in time order. That is, in the third state, in the display region, the speech recognition result text Full (T_{N+1}) of the section T_{N+1} that has not been displayed in the second state is displayed, the summary text Summ (T_{N}) is displayed for the section T_{N} in which the speech recognition result text Full (T_{N}) has been displayed in the second state, and the summary text of the section that is no longer displayable in the display region of the summary text of the past section that has been displayed in the second state is not displayed.

Note that, as illustrated in FIG. 4, a scroll bar slider RS may be provided in the display region. In the example of FIG. 4, the scroll bar slider RS is movable up and down. In the example of FIG. 4, the scroll bar slider RS is on the right side of the display region, but the scroll bar slider RS may be on the left side of the display region. In a case where the scroll bar slider RS is provided in the display region, the display of each state described above is an initial display state of each state, and in each initial display state, the scroll bar slider RS is at the lowest portion within the movable range.

For example, in the first state, when a moving operation of the scroll bar slider RS is performed upward, the lines of the speech recognition result text Full (T_{N}) of the latest section T_{N} that has been displayed in the initial display state are sequentially deleted from the bottom, and the summary text of the more past section that has not been displayed in the initial display state is added to the heads of the summary texts Summ (T_{N-1}), Summ (T_{N-2}), . . . of the consecutive past sections T_{N-1}, T_{N-2}, . . . including the section T_{N-1} immediately before the latest section.

When the user performs a moving operation on the scroll bar slider RS, the input unit 105 receives the moving operation and outputs operation information indicating the moving operation. The operation information output from the input unit 105 is input to the display information generation unit 6. The display information generation unit 6 newly generates display information corresponding to the position of the scroll bar slider RS on the basis of the input operation information, and outputs the newly generated display information to the display unit 7. The display unit 7 performs display based on the newly generated display information. Through these processes, scroll display based on the moving operation of the scroll bar slider RS is performed.

Although the display information newly generated by the display information generation unit 6 needs to include the summary text of the past section that has not been displayed in the initial display state, it is sufficient if the summary text input to the display information generation unit 6 during processing performed by the display information generation unit 6 in the past is used as the summary text of the past section that has not been displayed in the initial display state. Of course, the display information generation unit 6 may output instruction information for requesting the summary text of the past section to the summary processing unit 5, the summary processing unit 5 may read the speech recognition result text of the requested section from the utterance sentence storage unit 3 on the basis of the input instruction information, obtain the summary text by performing the summary processing on the read speech recognition result text, and output the obtained summary text to the display information generation unit 6, and the display information generation unit 6 may use the input summary text.

Note that FIG. 4 illustrates an example in which the speech recognition result text and the summary text are displayed horizontally in the display region, but the speech recognition result text and the summary text may be vertically displayed in the display region. In a case where the speech recognition result text and the summary text are vertically displayed and the scroll bar slider RS is provided, the scroll bar slider RS is only required to be movable to the left or right and provided on a lower side or an upper side of the speech recognition result text and the summary text, and the scroll bar slider RS is only required to be located at the leftmost portion within the movable range in the initial display state.

### Second Example of Display Region

Also in the second example of the display region, similarly to the first example of the display region, in the display region, the speech recognition result text of the latest section and the summary text of one or more sections immediately before the latest section are displayed in time order. The second example of the display region is different from the first example of the display region in that the scroll bar slider is not provided for the entire display region, but the scroll bar slider is provided in each of the first partial region R1 and the second partial region R2. Hereinafter, differences between the second example and the first example will be mainly described.

The display of the speech recognition result text and the summary text in the initial display state of the display region in the first state to the third state of the second example of the display region is the same as the display of the speech recognition result text and the summary text in the initial display state of the display region in the first state to the third state of the first example of the display region, respectively. However, each of the first partial region R1 and the second partial region R2 can be scrolled and displayed by the moving operation of the scroll bar slider.

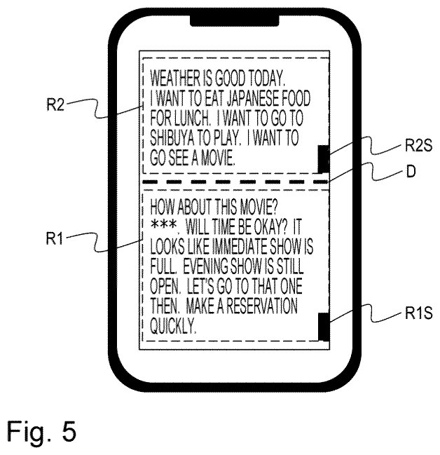

Specifically, as illustrated in FIG. 5, a scroll bar slider RIS is provided on the right side of the first partial region R1, and a scroll bar slider R2S is provided on the right side of the second partial region R2. The scroll bar slider RIS receives a user's moving operation for scroll display of the first partial region R1. The scroll bar slider R2S receives a user's moving operation for scroll display of the second partial region R2. In the initial display state, each of the scroll bar slider RIS and the scroll bar slider R2S is at the lowest portion within the movable range. Variations of the display of each text in the display region and the arrangement and movable range of each scroll bar slider, such as that the scroll bar slider only needs to be at the leftmost portion of the movable range when each text is horizontally written, are similar to those in the first example.

For example, in the first state, when a moving operation of the scroll bar slider R2S in the second partial region R2 is performed upward, in the second partial region R2, the lines of the summary texts Summ (T_{N-1}), Summ (T_{N-2}), of the past consecutive sections T_{N-1}, T_{N-2}, . . . including the section T_{N-1} immediately before the latest section that has been displayed in the initial display state are sequentially deleted from the bottom, and the summary text of the past section that has not been displayed in the initial display state is added to the top.

When the user performs a moving operation on the scroll bar slider R2S, the input unit 105 receives the moving operation and outputs second operation information that is operation information indicating the moving operation on the scroll bar slider R2S. The second operation information output from the input unit 105 is input to the display information generation unit 6. The display information generation unit 6 newly generates display information including the display content of the second partial region R2 corresponding to the position of the scroll bar slider R2S on the basis of the input second operation information, and outputs the newly generated display information to the display unit 7. The display unit 7 performs display based on the newly generated display information. Through these processes, scroll display based on the moving operation of the scroll bar slider R2S is performed.

For example, in the first state, when a moving operation of the scroll bar slider R1S in the first partial region R1 is performed upward, in the first partial region R1, the lines of the speech recognition result text Full (TN) in the latest section T_{N} that has been displayed in the initial display state are sequentially deleted from the bottom, and the speech recognition result text of the past section that has not been displayed in the initial display state is added to the upper side.

When the user performs a moving operation on the scroll bar slider R1S, the input unit 105 receives the moving operation and outputs first operation information that is operation information indicating the moving operation on the scroll bar slider R1S. The first operation information output from the input unit 105 is input to the display information generation unit 6. The display information generation unit 6 newly generates display information including the display content of the first partial region R1 corresponding to the position of the scroll bar slider R1S on the basis of the input first operation information, and outputs the newly generated display information to the display unit 7. The display unit 7 performs display based on the newly generated display information. Through these processes, scroll display based on the moving operation of the scroll bar slider R1S is performed.

Although the display content of the first partial region R1 newly generated by the display information generation unit 6 needs to include the speech recognition result text of the past section that has not been displayed in the initial display state, it is sufficient if the speech recognition result text input to the display information generation unit 6 during the processing performed by the display information generation unit 6 in the past is used as the speech recognition result text of the past section that has not been displayed in the initial display state. Of course, the display information generation unit 6 may read the speech recognition result text of the past section from the utterance sentence storage unit 3 and use the read speech recognition result text.

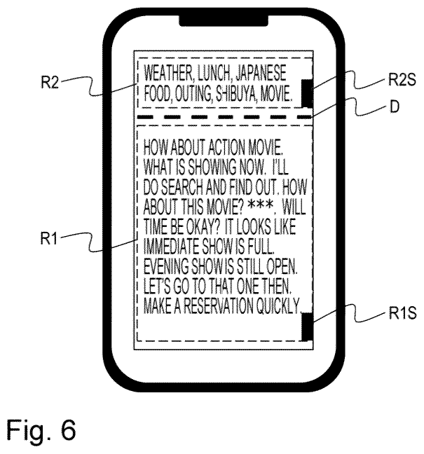

Note that FIG. 5 is an example in which the summary text of a plurality of consecutive past sections including the section immediately before the latest section displayed in the display region is a summary text including summary Sentences, and FIG. 6 is an example in which the summary text of a plurality of consecutive past sections including the section immediately before the latest section displayed in the display region is a summary text including content words only. That is, the displayed summary text may include a summary sentence of the speech recognition result text of the past utterance as in the example of FIG. 5, or may include only content words of the speech recognition result text of the past utterance as in the example of FIG. 6.

As illustrated in FIGS. 5 and 6, a partition D may be displayed between the first partial region R1 and the second partial region R2. In the examples of FIGS. 5 and 6, the partition D is a broken line. When the partition D is present between the first partial region R1 and the second partial region R2, the user can clearly distinguish the first partial region R1 and the second partial region R2.

The partition D may be at a predetermined position in the display region. However, when the partition D is at a predetermined position in the display region, the maximum number of characters that can be displayed in the first partial region R1 is determined. Therefore, in a case where the partition D is at a predetermined position in the display region, and in a case where the number of characters of the speech recognition result text of the latest section exceeds the maximum number of characters that can be displayed in the first partial region R1, it is only required to display the text corresponding to the maximum number of characters of newer one of the speech recognition result texts in the latest section.

The partition D may be movably operable. When the partition D is movably operable, the size of the first partial region R1 and the size of the second partial region R2 are changed by performing a moving operation of the partition D. In the enlarged partial region, it is only required to add and display a temporally past text. Specifically, when the second partial region R2 is enlarged, the summary text of the past section that has not been displayed before being enlarged is added to the upper side. More specifically, in a case where the first partial region R1 is enlarged, the speech recognition result text that has not been displayed before being enlarged is added to the upper side. In a case where the first partial region R1 is enlarged and the maximum number of characters that can be displayed in the first partial region R1 becomes larger than the number of characters of the speech recognition result text of the latest section, as illustrated in FIG. 6, a newer part of the speech recognition result texts of consecutive past sections including the section immediately before the latest section may also be displayed in the first partial region R1 above the speech recognition result text in the latest section.

### Third Example of Display Region

Also in the third example of the display region, similarly to the first example and the second example of the display region, in the display region, the speech recognition result text of the latest section and the summary text of or more sections immediately before the latest section are displayed in time order. The third example of the display region is different from the first example and the second example of the display region in that the summary text displayed in the display region is selectable. Hereinafter, differences of the third example from the first example and the second example will be described with reference to the example of FIG. 6.

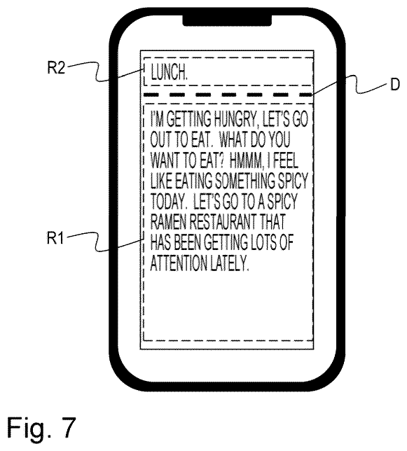

When any one of the plurality of summary texts displayed in the display region of the screen of the display unit 7 is selected, the screen of the display unit 7 is switched to display in which the selected summary text and the speech recognition result text corresponding to the selected summary text are associated with each other. For example, when a summary text “lunch” of “weather”, “lunch”, “Japanese food”, “outing”, “Shibuya”, and “movie” which are six summary texts in FIG. 6 is selected, the screen of the display unit 7 is switched to a display in which “lunch” which is the selected summary text and “I'm getting hungry˜” which is the speech recognition result text corresponding to “lunch” which is the selected summary text are associated with each other as illustrated in FIG. 7. In FIG. 7, as the selected summary text, the selected summary text “lunch” is displayed in the second partial region R2. Further, in FIG. 7, as the speech recognition result text, “I'm getting hungry˜” which is the speech recognition text corresponding to the content word “lunch”, which is the selected summary text, is displayed in the first partial region R1. The speech recognition text corresponding to the summary text is the speech recognition text that is a summary source of the summary text, and is the speech recognition text in the same section as the summary text.

As described above, the summary text is selectable, and when the summary text is selected, the display may be switched to a display in which the selected summary text and the speech recognition result text corresponding to the selected summary text are associated with each other.

That is, each of the one or more summary texts displayed in the display region is selectable, and when a summary text is selected on the basis of the selection information input to the display information generation unit 6, the display information generation unit 6 may newly generate display information for displaying the selected summary text and the speech recognition result text corresponding to the selected summary text in association with each other, and output the newly generated display information to the display unit 7. In this case, the display unit 7 performs display based on the newly generated display information.

### Display Unit 7

The display information generated by the display information generation unit 6 is input to the display unit 7.

The display unit 7 is a display device having a screen such as a liquid crystal display (LCD) or an organic electroluminescence display (OLED).

The display unit 7 performs display based on the display information. Thus, the display unit 7 displays, in the display region of the utterance content in the screen, the speech recognition result text that is a text of a speech recognition result of the latest utterance and the summary text that is a text obtained by summarizing the speech recognition result text of the utterance that is more past than the latest utterance (step S7).

An example of the display by the display unit 7 has been described in the description part of the display information generation unit 6, and thus redundant description will be omitted here.

As described above, for the latest utterance, the speech recognition result text is displayed because importance of an uttered word itself is higher than that of a past utterance, and for an utterance that is more past than the latest utterance, the summary text is displayed because the information included in the utterance is important although the importance of the uttered word itself is not as high as that of the latest utterance, whereby it is possible to display the utterance content so that the display is not difficult to visually recognize even when the size of the display screen for displaying the utterance content is restricted.

Note that, in the above-described embodiment, an example in which each unit sequentially performs processing has been described, but at the time of performing display, each component of the speech recognition result display device may perform processing on a digital sound signal up to the time of performing display.

### Modification

The first partial region R1 and the second partial region R2 may have any positional relationship as long as they are adjacent to each other. For example, the first partial region R1 and the second partial region R2 may be vertically adjacent to each other, or may be horizontally adjacent to each other.

As described above, the first partial region R1 is a region where the speech recognition result text is displayed, and the second partial region R2 is a region where the summary text is displayed. It can be said that the speech recognition result text and the summary text are texts of continuous contents belonging to the same time Series.

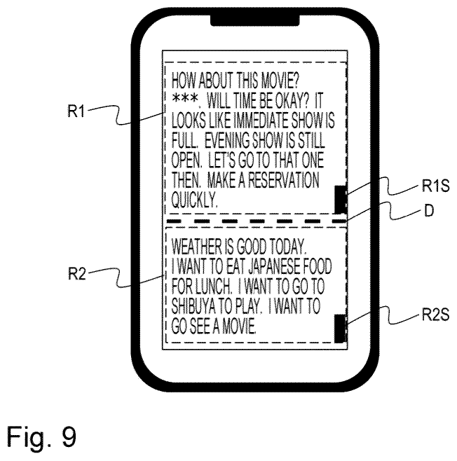

For example, as illustrated in FIG. 9, the first partial region R1 and the second partial region R2 may be adjacent to each other so that the first partial region R1 is above the second partial region R2 by the presence of the first partial region R1 in an upper portion of the display region and the second partial region R2 in a lower portion of the display region.

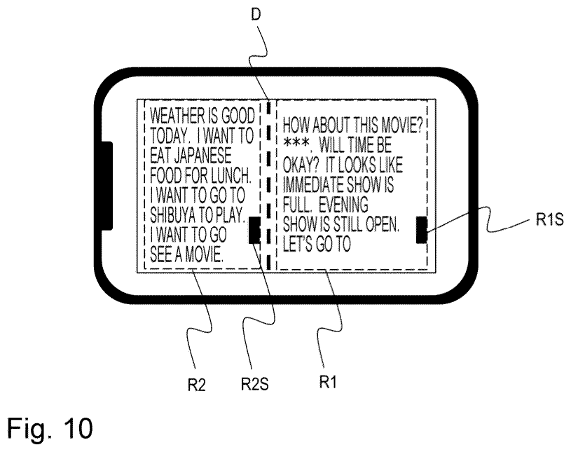

Further, as illustrated in FIG. 10, the first partial region R1 and the second partial region R2 may be adjacent to each other so that the first partial region R1 is on the right side of the second partial region R2 by the presence of the first partial region R1 on the right side of the display region and the second partial region R2 on the left side of the display region.

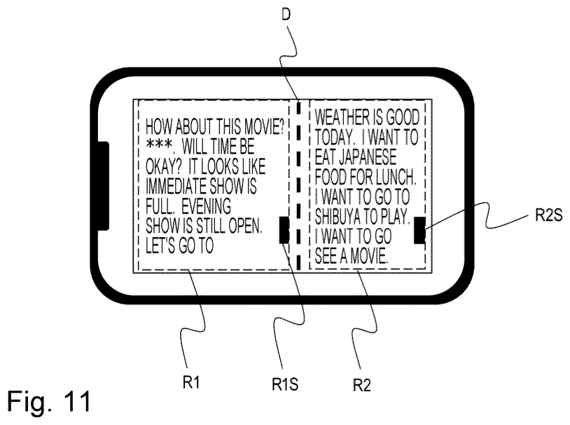

Furthermore, As Illustrated in FIG. 11, the First partial region R1 and the second partial region R2 may be adjacent to each other so that the first partial region R1 is on the left side of the second partial region R2 by the presence of the first partial region R1 on the left side of the display region and the second partial region R2 on the right side of the display region.

Note that, as illustrated in FIGS. 9 to 11, even if there is a partition D indicating a boundary between the first partial region R1 and the second partial region R2, it can be said that the first partial region R1 and the second partial region R2 are adjacent to each other.

Note that the summary text may be a text determined from a summary viewpoint specified by the user.

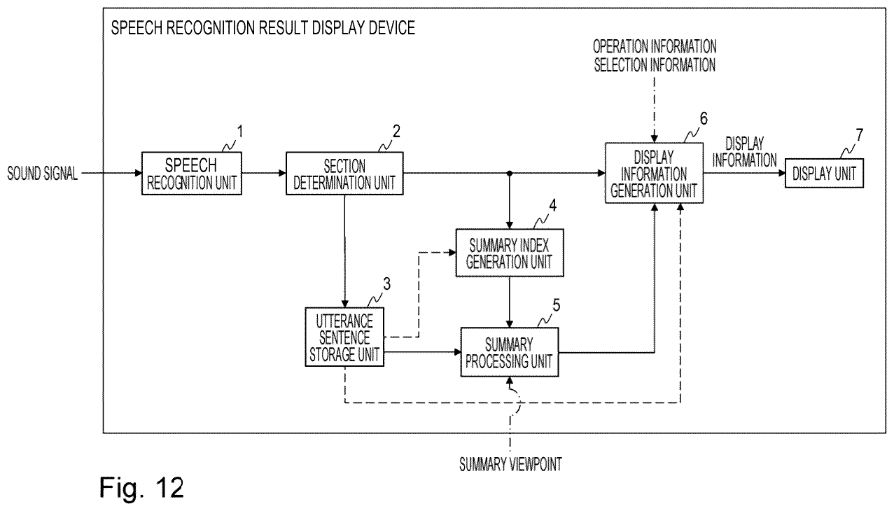

For example, as indicated by a two-dot chain line in FIG. 12, a summary viewpoint is further input to the summary processing unit 5. The summary viewpoint is a viewpoint for generating a summary including a specific viewpoint, and corresponds to, for example, a word or the like. The summary processing unit 5 further obtains a summary text by using the summary viewpoint. More specifically, the summary processing unit 5 performs summary processing on the speech recognition result text of each section to be subjected to the summary display according to the summary index and the summary viewpoint to obtain the summary text of each section.

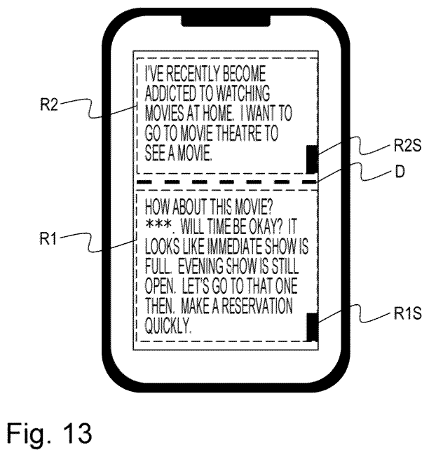

For example, it is assumed that a summary viewpoint specified by the user is a word “movie”. In this case, as illustrated in FIG. 13, the summary text generated according to the summary viewpoint of “movie” is displayed in the second partial region R2.

In a case where both the summary index and the summary viewpoint cannot be achieved, the summary processing unit 5 obtains the summary text according to one of the summary index and the summary viewpoint. An example of the case where both the summary index and the summary viewpoint cannot be achieved is a case where the summary index is the recommended number of characters of 80 characters and the summary viewpoint includes an output length of 50 characters. Note that, in the case where both the summary index and the summary viewpoint cannot be achieved, the summary processing unit 5, the display information generation unit 6, and the display unit 7 may display that an error has occurred.

The summary viewpoint may include a focus of Reference Literature 1. The focus is a character string indicating a point of interest regarding sentence generation. In a case where the focus is included in the summary viewpoint, the summary processing unit 5 estimates an importance level of each word by using at least the focus, and generates the summary text on the basis of the estimated importance level (see, for example, Reference Literature 1).

### [Reference Literature 1] WO2020179512A1

The summary viewpoint may include an output length of Reference Literature 2. The output length is a length of a generated sentence. When the output length is included in the summary viewpoint, the summary processing unit 5 generates the summary text so that the length of the summary text becomes the output length (see, for example, Reference Literature 2).

### [Reference Literature 2] WO2020179530A1

The summary viewpoint may include “information different from an input sentence” of Reference Literature 3. The “information different from an input sentence” is information different from the speech recognition result text of each section to be subjected to summary display as an input sentence, and is, for example, external knowledge. The external knowledge is, for example, a text format document (a set of sentences). When the summary viewpoint includes “information different from the input sentence”, the summary processing unit 5 generates a reference text by using at least the “information different from an input sentence”, and generates the summary text by using the generated reference text (see, for example, Reference Literature 3).

### [Reference Literature 3] WO2021065034A1

The designation of the summary viewpoint by the user is performed by, for example, an input device such as a keyboard, a mouse, a touch pad, a trackball, or a joystick.

The user may input text to be a summary viewpoint using the input device, or the user may select a desired summary viewpoint from a predetermined summary viewpoint using the input device. In this case, the input or selected summary is input to the summary processing unit 5.

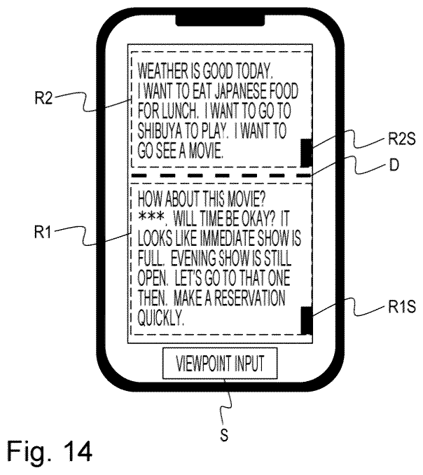

As illustrated in FIG. 14, the display region may include a summary viewpoint designation region S for the user to designate the summary viewpoint. It can also be said that the summary viewpoint designation region S is a region serving as a trigger for inputting a viewpoint. The user's operation on the summary viewpoint designation region S starts designation of the summary viewpoint. In the example of FIG. 14, the summary viewpoint designation region S is a button on which characters “viewpoint input” are depicted. In this example, it is assumed that when the user presses the button, voice input is enabled. When the user utters a voice after the user presses the button, speech recognition of the voice is input to the summary processing unit 5 as a summary viewpoint.

Note that the summary viewpoint designation region S may be a region other than the button as long as it is a region for designating the summary viewpoint. Examples of the region other than the button include a character string in which an input box, a list box, and a link are embedded. In addition, all or part of the display region may be the summary viewpoint designation region S, and the summary viewpoint may be input by performing a swipe operation in the summary viewpoint designation region S.

The summary processing unit 5 may present a desired summary viewpoint to the user via the display information generation unit 6 and the display unit 7 so that the user can select the desired summary viewpoint. For example, the summary processing unit 5 selects, as a summary viewpoint, at least one frequently appearing word from the speech recognition result text read from the utterance sentence storage unit 3. The frequently appearing word is a word that appears a predetermined number of times or more. The selected at least one frequently appearing word that is a summary viewpoint is output to the display information generation unit 6. The display information generation unit 6 causes the display unit 7 to display at least selected and at least one frequently appearing word that is a summary viewpoint.

Note that the summary processing unit 5 may obtain a summary viewpoint obtained by extending the input summary viewpoint using a predetermined dictionary. In this case, the summary processing unit 5 performs summary processing on the speech recognition result text of each section to be subjected to the summary display according to the summary index and the extended summary viewpoint to obtain the summary text of each section.

In the predetermined dictionary, each word is associated with a related word of each word. For example, it is assumed that a related word “movie” is associated with each title of a movie (including a title of a foreign movie and a title of a Japanese movie) and a word indicating each genre of the movie. Furthermore, it is assumed that a title of a certain movie is input to the summary processing unit 5 as a summary viewpoint. In this case, the summary processing unit 5 obtains a “movie” as a summary viewpoint obtained by extending a title of a movie that is an input summary viewpoint, using a predetermined dictionary. Then, the summary processing unit 5 performs summary processing on the speech recognition result text of each section to be subjected to the summary display according to the summary index and “movie” that is an extended summary viewpoint to obtain the summary text of each section.

The summary processing unit 5 may generate the summary text using a generative AI which is an AI capable of generating new content on the basis of learned data. An example of the generative AI is a generative AI described in Reference Literature 4.

[Reference Literature 4] OpenAI, [online], [retrieved on Jul. 11, 2023], the Internet
<URL: https://openai./m/chatgpt>

For example, the speech recognition result text, the summary index, and the summary viewpoint of each section to be subjected to the summary display are input to the generative AI used in the summary processing unit 5. The generative AI performs summary processing on the speech recognition result text of each section to be subjected to the summary display according to the summary index and the summary viewpoint to obtain the summary text of each section. Note that the summary viewpoint may be instructed by a natural language instruction.

### Program, Recording Medium, or the Like

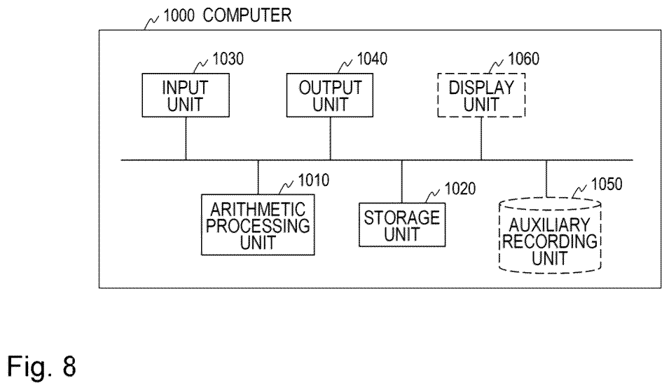

The processing of each unit of the speech recognition result display device described above may be implemented by a computer, and in this case, the processing content of the function that the speech recognition result display device should have is described by a program. Then, by causing a storage unit 1020 of a computer 1000 illustrated in FIG. 8 to read this program and causing an arithmetic processing unit 1010, an input unit 1030, an output unit 1040, a display unit 1060, and the like to operate, various processing functions of the speech recognition result display device are achieved on the computer.

The speech recognition result display device described above includes, for example, as a single hardware entity, an input unit to which a signal can be input from the outside of the hardware entity, an output unit through which a signal can be output to the outside of the hardware entity, a communication unit to which a communication device (for example, a communication cable) capable of communicating with the outside of the hardware entity can be connected, a central processing unit (CPU which may include a cache memory, a register, and the like) which is an arithmetic processing unit, random access memory (RAM) and read only memory (ROM) which are memories, an external storage device which is a hard disk, and a bus connected so that the input unit, the output unit, the communication unit, the CPU, the RAM, the ROM, and the external storage device can exchange data. In addition, if necessary, a device (drive) or the like that can read and write a recording medium such as a CD-ROM may be provided in the hardware entity. Examples of a physical entity including such a hardware resource include a general-purpose computer.

The external storage device of the hardware entity stores programs required for implementing the above-described functions, data required for processing of the programs, and the like (the programs may be stored, for example, in a ROM as a read-only storage device instead of the external storage device). In addition, such data or the like obtained by the processing by the program is appropriately stored in the RAM, the external storage device, or the like.

In the hardware entity, each program stored in the external storage device (or the ROM or the like) and data required for processing by each program are read into a memory as necessary and are appropriately interpreted, executed, and processed by the CPU. As a result, the CPU implements predetermined functions (each of the components represented as . . . unit or the like). That is, each of the components of the embodiment of the present invention may include processing circuitry.

As described earlier, in a case where the processing functions of the hardware entity (each device described above) described in the foregoing embodiment are implemented by a computer, processing contents of the functions that the hardware entity is supposed to have are described by a program. The computer then executes this program, whereby the processing functions of the hardware entity are implemented in the computer.

The program in which the processing content is written can be recorded on a computer-readable recording medium. The computer-readable recording medium is, for example, a non-transitory recording medium and is specifically a magnetic recording device, an optical disc, or the like.

In addition, distribution of the program is performed by, for example, selling, transferring, or renting a portable recording medium such as a DVD or a CD-ROM on which the program is recorded. Further, a configuration may also be employed in which the program is stored in a storage device in a server computer and the program is distributed by transferring the program from the server computer to other computers via a network.

For example, the computer that executes such a program first temporarily stores the program recorded in a portable recording medium or the program transferred from a server computer in an auxiliary recording unit 1050 that is a non-transitory storage device thereof. Then, at the time of performing processing, the computer reads the program stored in the auxiliary recording unit 1050 serving as the non-transitory storage device of the computer into the storage unit 1020 and performs processing according to the read program. In addition, as another mode of executing the program, the computer may directly read the program from the portable recording medium into the storage unit 1020 and execute processing according to the program, or, each time the program is transferred from the server computer to the computer, the computer may sequentially execute processing according to the received program. In addition, the above-described processing may be executed by a so-called application service provider (ASP) type service that implements a processing function only by an execution instruction and result acquisition without transferring the program from the server computer to the computer. Note that the program in this mode includes information that is to be used in processing by an electronic calculator and is equivalent to the program (data and the like that are not direct commands to the computer but have properties that define the processing to be performed by the computer).

In addition, in this mode, the present device is configured by executing a predetermined program on the computer, but at least part of the processing content may be implemented by hardware.

Additionally, it is needless to say that changes can be appropriately made without departing from the gist of this invention.

All documents, patent applications, and technical standards described in this specification are incorporated herein by reference to the same extent as in a case where incorporation by reference of each document, patent application, and technical standard is specifically and individually described.

1. A speech recognition result display device, comprising:
a display that displays a speech recognition result text that is a text of a speech recognition result of a latest utterance and a summary text that is a text obtained by summarizing the speech recognition result text of an utterance that is more past than the latest utterance in a display region of an utterance content in a screen.

2. A speech recognition result display device, comprising:
a display that displays a speech recognition result text that is a text of a speech recognition result of a latest utterance and a summary text that is a text obtained by summarizing the speech recognition result text of an utterance that is more past than the latest utterance in a display region of an utterance content in a screen, wherein
each of one or more of summary texts displayed in the display region is selectable, and
when any of the summary texts is selected, display in the display region is switched to display in which selected summary text and the speech recognition result text corresponding to the selected summary text are associated with each other.

3. The speech recognition result display device according to claim 1, wherein
the display region includes a first partial region in which the speech recognition result text is displayed and a second partial region which is a partial region in which the summary text is displayed, and
the first partial region and the second partial region are adjacent to each other.

4. The speech recognition result display device according to claim 1, wherein
the summary text is a text determined from a summary viewpoint specified by a user.

5. The speech recognition result display device according to claim 4, wherein
the display region includes a summary viewpoint designation region for the user to designate the summary viewpoint.

6. The speech recognition result display device according to claim 3, wherein
the display region includes a first partial region in which the speech recognition result text is displayed and a second partial region which is a partial region in which the summary text is displayed,
in the first partial region, a speech recognition result text corresponding to the latest utterance and a speech recognition result text corresponding to a past utterance are displayable in a scrollable manner, and
in the second partial region, a summary text of a past utterance not including the latest utterance is displayable in a scrollable manner.

7. The speech recognition result display device according to claim 3, wherein
the summary text includes only a content word of the speech recognition result text of past utterance.

8. The speech recognition result display device according to claim 3, wherein
each of one or more summary texts displayed in the display region is selectable, and
when any of the summary texts is selected, display in the display region is switched to display in which selected summary text and the speech recognition result text corresponding to the selected summary text are associated with each other.

9. A speech recognition result display method, comprising:
displaying, by a display in a display region of an utterance content in a screen, a speech recognition result text that is a text of a speech recognition result of a latest utterance and a summary text that is a text obtained by summarizing the speech recognition result text of an utterance that is more past than the latest utterance.

10. (canceled)

11. A non-transitory computer readable medium storing instructions that, when executed by a processor, cause the processor to perform the method of claim 9.
